(19) United States
(12) Patent Application Publication
(10) Pub. No.: US 2010/0207400 A1
(43) Pub. Date: Aug. 19, 2010

(54) Door Latch with Fast Unlock

(76) Inventors: Kris Tomaszewski, Ontario (CA); Francesco Cumbo, Pisa (IT)

Correspondence Address: MAGNA INTERNATIONAL, INC., 337 MAGNA DRIVE, AURORA, ON, L4G-7K1, CA

(21) Appl. No.: 12/682,096

(22) PCT Filed: Oct. 10, 2008
(86) PCT No.: PCT/CA08/01807

§ 371 Date: Apr. 8, 2010

Related U.S. Application Data
(60) Provisional application No. 60/978,800, filed on Oct. 10, 2007.
(60) Provisional application No. 61/075,379, filed on Jun. 25, 2008.

(51) Int. Cl. E05B 65/32; E05C 3/16

(52) U.S. Cl. 292/196; 292/200

(57) ABSTRACT

In one aspect, the invention is directed to a closure latch for a vehicle door. The closure latch includes a ratchet movable between an open position and a closed position, a first door release lever operatively connected to the ratchet, a second door release lever, and a lock lever movable along a lock lever path including a first lock lever position wherein the second door release lever is operatively disconnected from the first door release lever, a second lock lever position wherein the lock lever operatively connects the second door release lever to the first door release lever, and a third lock lever position wherein the lock lever carries out an additional function.

### FIELD OF THE INVENTION

The present invention relates to a closure latch for a vehicle door, and more particularly to a closure latch for a vehicle door equipped with a passive entry feature.

### BACKGROUND OF THE INVENTION

Passive entry systems for vehicles are provided on some vehicles to permit a vehicle user who is in possession of the vehicle key to simply pull the door handle and open the door without the need to introduce the key into a keyhole in the door. The key (more particularly, the key fob) is equipped with an electronic device that communicates with the vehicle's on-board control system to authenticate the user. When the user pulls the door handle to indicate that he/she wishes entry into the vehicle, it would be advantageous for the vehicle to unlock the door relatively quickly so that he/she does not have to wait an unduly long time before being permitted to open the door.

### SUMMARY OF THE INVENTION

In one aspect, the invention is directed to a closure latch for a vehicle door. The closure latch includes a ratchet movable between an open position and a closed position, a first door release lever operatively connected to the ratchet, a second door release lever, and a lock lever movable along a lock lever path including a first lock lever position wherein the second door release lever is operatively disconnected from the first door release lever, a second lock lever position wherein the lock lever operatively connects the second door release lever to the first door release lever, and a third lock lever position wherein the lock lever carries out an additional function.

### BRIEF DESCRIPTION OF THE DRAWINGS

The present invention will now be described by way of example only with reference to the attached drawings, in which:

FIG. 1a is an elevation view of a portion of a closure latch for a vehicle door in accordance with an embodiment of the present invention, showing a lock lever in a first position;

FIG. 1b is a plan view of another portion of the vehicle latch shown in FIG. 1a with some components shown as transparent for greater clarity;

FIG. 1c is a magnified perspective view of a portion of the closure latch shown in FIG. 1b;

FIG. 1d is an elevation view of the portion of the closure latch shown in FIG. 1c;

FIG. 1e is another magnified perspective view of the portion of the closure latch shown in FIG. 1b with some components shown as transparent for greater clarity;

FIG. 2a is an elevation view of the closure latch shown in FIG. 1a, showing the lock lever in a second position;

FIG. 2b is a plan view of the closure latch shown in FIG. 2a;

FIG. 2c is a magnified perspective view of a portion of the closure latch shown in FIG. 2b;

FIG. 2d is an elevation view of the portion of the closure latch shown in FIG. 2c;

FIG. 2e is another magnified perspective view of the portion of the closure latch shown in FIG. 2b with some components shown as transparent for greater clarity; and

FIG. 3 is an elevation view of the closure latch shown in FIG. 1a, showing the lock lever in a third position.

### DETAILED DESCRIPTION OF THE INVENTION

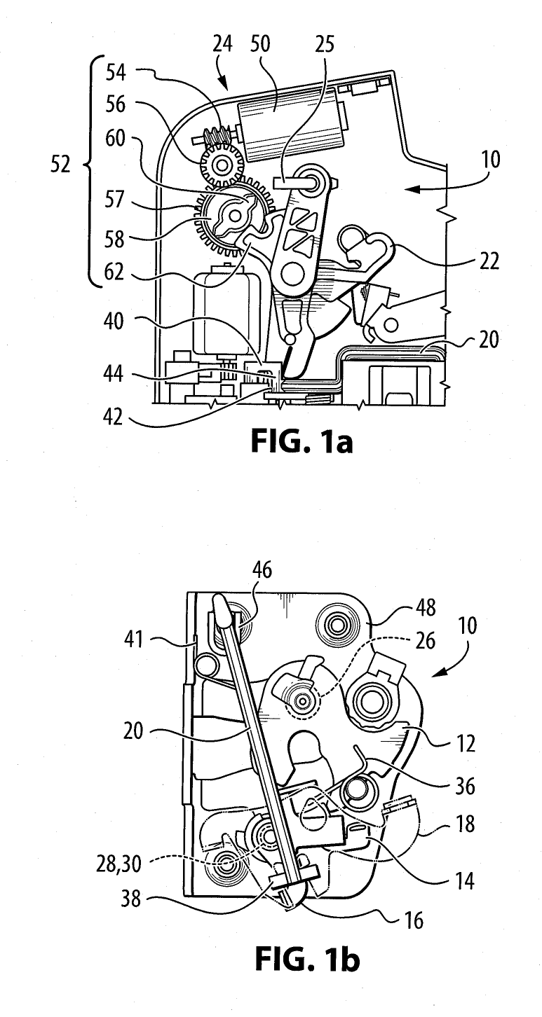

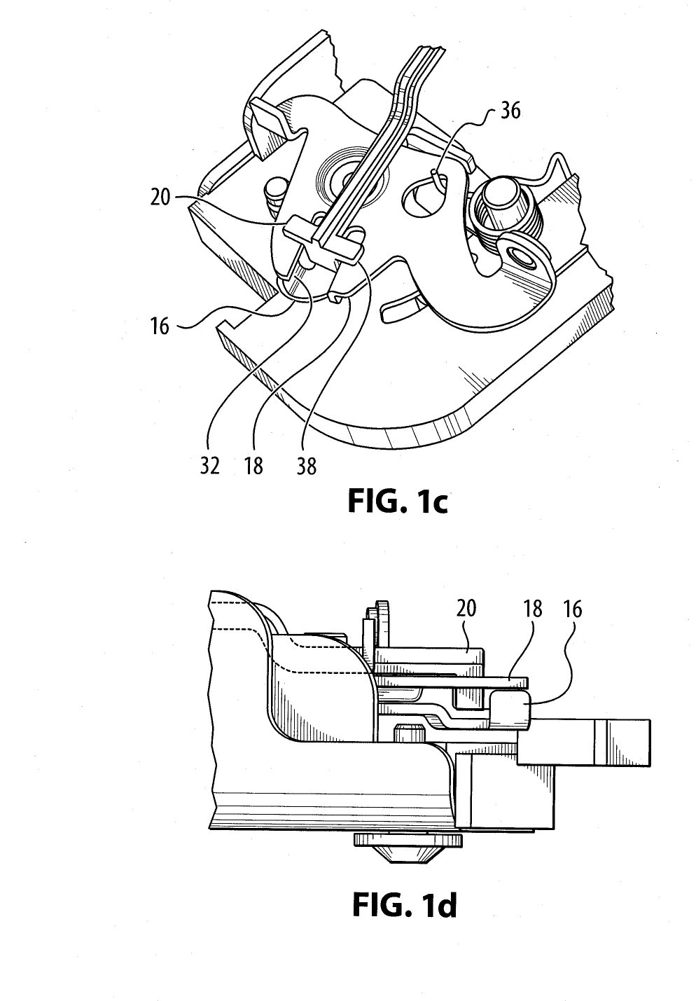

Reference is made to FIGS. 1a and 1b, which show portions of a closure latch 10 for a door (not shown) of a vehicle (not shown), in accordance with an embodiment of the present invention.

The closure latch 10 includes a ratchet 12 (FIG. 1b), a pawl 14 (FIG. 1b), a first door release lever 16 (FIG. 1c), a second door release lever 18 (FIG. 1b), a lock link 20 (FIG. 1b), a lock lever 22 (FIG. 1a), a lock lever actuator 24 (FIG. 1a) and a lock knob assembly 25 (a small portion of which is shown in FIG. 1a).

Referring to FIG. 1b, the ratchet 12 is movable between a closed position (FIG. 1b) wherein the ratchet 12 retains a striker (not shown) mounted on the body (not shown) of the vehicle and an open position wherein the ratchet 12 is unengaged with the striker. A ratchet biasing member 26 such as a suitable spring may be provided to bias the ratchet 12 towards the open position.

The pawl 14 is movable between a ratchet locking position (FIG. 1b) wherein the pawl 14 holds the ratchet 12 in the closed position, and a release position wherein the pawl 14 permits the ratchet 12 to move to its open position. A pawl biasing member 28 such as a suitable spring may be provided to bias the pawl 14 towards the ratchet locking position.

The first door release lever 16 is operatively connected to the ratchet 12 for movement from the closed position to the open position. The first door release lever 16 may be operatively connected to the ratchet 12 in any suitable way, such as by direct mechanical engagement (See FIG. 1e). The first door release lever 16 may be movable from a rest position to a door release position (not shown) wherein it moves the pawl 14 to the release position (not shown) so that the ratchet 12 can be moved from the closed position to the open position under the urging of the ratchet biasing member 26.

A first door release lever biasing member 30, such as a suitable spring, may be provided to bias the first door release lever 16 towards its rest position. Instead of having a first door release lever biasing member 30 that is dedicated solely to moving the first door release lever 16 to its rest position, it is possible for the pawl 14 to move the first door release lever 16 to its rest position, during movement of the pawl 14 to its ratchet locking position under the urging of the pawl biasing member 28. Thus, the pawl biasing member 28 may act as a first door release lever biasing member 30 as shown in FIG. 1b.

The first door release lever 16 (FIG. 1c) has a first lock link engagement surface 32 which is configured to be engaged by the lock link 20.

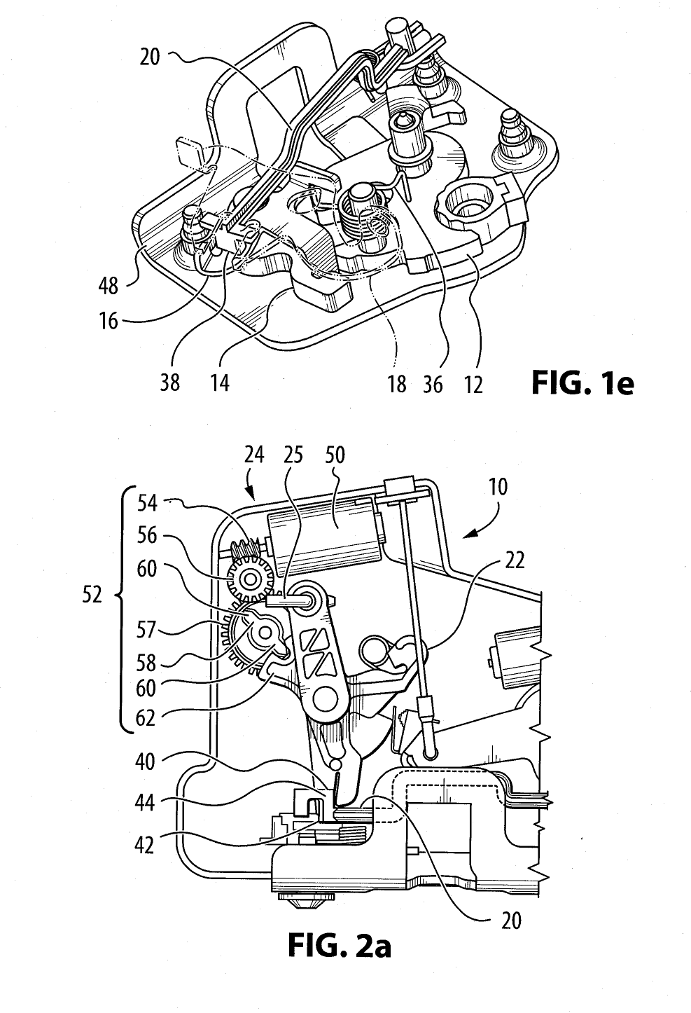

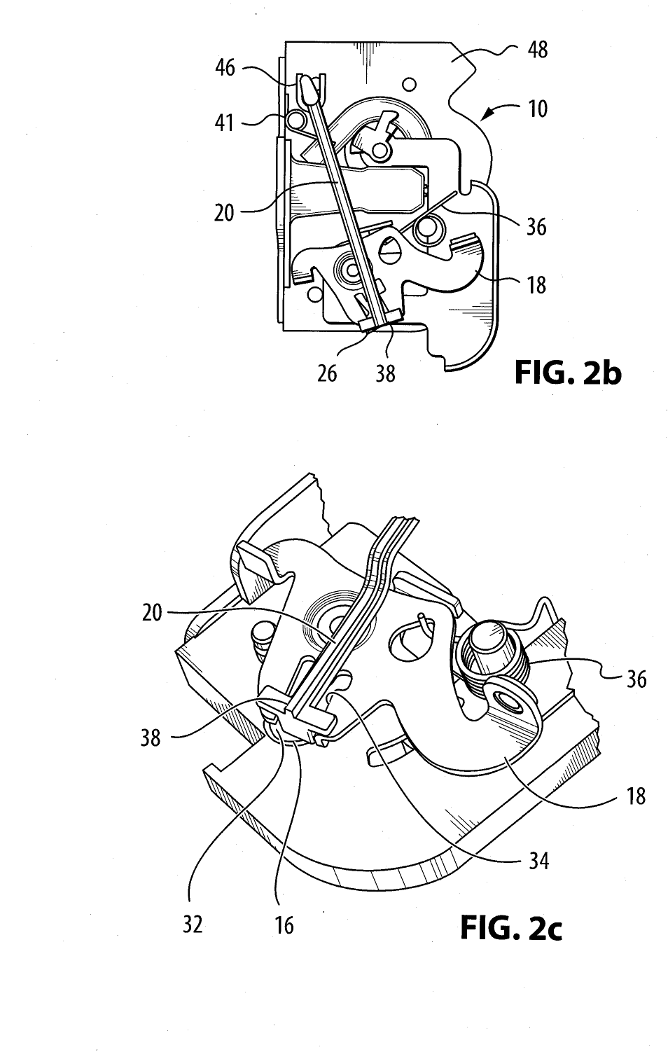

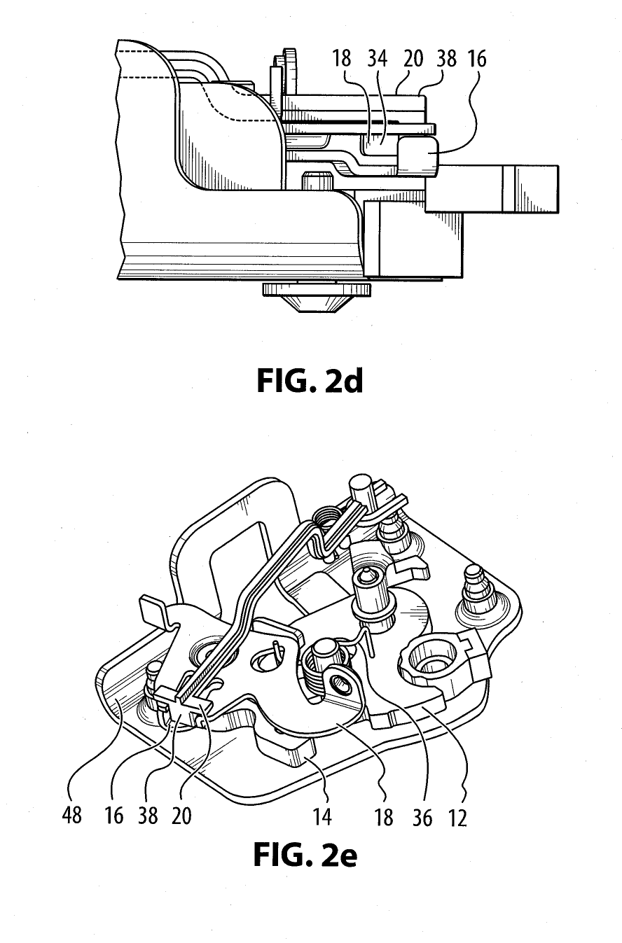

The second door release lever 18 (FIG. 2c) is operatively connectable to the first door release lever 16. The second door release lever 16 may be operatively connectable to the first door release lever 16 in any suitable way, such as through the lock link 20. The second door release lever 18 includes a second lock link engagement surface 34 that is positioned to engage the lock link 20. The second door release lever 18 may be movable from a rest position (FIG. 1c) to a door release position (not shown), which is described further below.

A second door release lever biasing member 36, such as a suitable spring, may be provided to bias the second door release lever 18 towards its rest position.

The second door release lever 18 may be moved from its rest position to its door release position by one or more means, such as by movement of an outer door handle (not shown) on the outside of the vehicle door (not shown).

The lock link 20 may be movable between a first lock link position 20 (FIGS. 1a-1e) wherein the lock link 20 is disengaged from the first door release lever, and a second lock link position (FIGS. 2a-2e) wherein the second door release lever 18 is operatively connected to the first door release lever 16 through the lock link 20. More specifically, when a person pulls the outside door handle the second door release lever 18 is moved from its rest position to its door release position and moves a first end 38 of the lock link 20 with it. If the lock link 20 is in the first position (FIGS. 1a-1e) and the person pulling the vehicle door handle is not in possession of an electronic vehicle key, then the first end 38 of the lock link 20 will sweep past the first lock link engagement surface 32 during movement of the second door release lever 18 to its door release position. As a result, the first door release lever 16 will not be moved to its door release position and the ratchet 12 will remain in its closed position.

When the lock link 20 is in the second position (FIGS. 2a-2e) and the second door release lever 18 is moved from its rest position to its door release position, the first end 38 of the lock link 20 is positioned to engage the first lock link engagement surface 32 and will move the first door release lever 16 to its door release position (not shown) thereby moving the pawl 14 and ratchet 12 to open the vehicle door.

The lock link 20 may be biased towards the second lock link position (FIG. 2b), by any suitable means, such as by a suitable spring 41.

The second end of the lock link 20 is shown at 40 in FIG. 1a. At the second end 40, the lock link 20 has a guide pin 42 and a lock lever engagement member 44. The guide pin 42 engages a guide channel 46 that is fixedly connected to a latch housing member 48. The guide channel 46 and the guide pin 42 together guide the movement of the lock link 20 between its first and second positions.

The guide pin 42 is rotatable within the guide channel 46 (FIG. 1b). This permits the lock link 20 to pivot as necessary during movement of the second door release lever 18 between its rest position and its door release position.

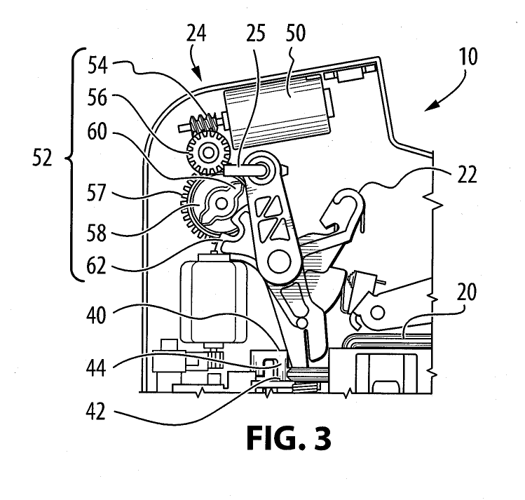

The lock lever engagement member 44 is engageable by the lock lever 22 (FIG. 1a). The lock lever 22 is movable between a first position (FIG. 1a), a second position (FIG. 2a) and a third position (FIG. 3). In the first position, the lock lever 22 holds the lock link 20 in the first lock link position (FIGS. 1a-1e). Additionally, when the lock lever 22 is in the first position, the lock knob assembly 25 is in a locked lock knob assembly position. When the lock lever 22 is in the second position (FIG. 2a), it permits the lock link 20 to move to the second lock link position (FIG. 2b) under the urging of the lock link biasing member 41 (FIG. 2b), thereby providing an operative connection from the second door release lever 18 to the first door release lever 16. Additionally, when the lock lever 22 is in the second position, the lock knob assembly 25 may be moved from the locked lock knob assembly position to an intermediate position (FIG. 2a) on the way to an unlocked lock knob assembly position (FIG. 3).

As the lock lever 22 moves away from the second position towards the third position, it may disengage from the lock link 20. The movement of the lock lever 22 to the third position causes the lock knob assembly 25 to move to the unlocked lock knob assembly position.

Rotation of the lock lever 22 from the first position towards the third position is in an unlocking direction. Rotation of the lock lever 22 from the third position towards the first position is in a locking direction.

The lock lever actuator 24 moves the lock lever 22 along the lock lever path between the first and third positions. Referring to FIG. 1a, the lock lever actuator 24 includes a motor 50 and a linkage 52 that operative connects the motor 50 to the lock lever 22. The linkage 52 may include a worm gear 54 driven directly by the motor 50, a first spur gear 56 driven by the worm gear 54, a second spur gear 57 driven by the first spur gear 56 and a lobed member 58 with at least one lobe 60 integrally connected to the second spur gear 57. A lobe receiving member 62 may be included as part of the lock lever 22 for receiving the lobe 60 and being driven thereby.

The movement of the lock knob assembly 25 between its locked and unlocked positions may require significantly more torque than the movement of the lock link 20 between its first and second positions. As a result, there is a relationship between the strength (and therefore cost) of the motor 50, the effective torque increase that takes place in the linkage 54 and the time required to carry out the movement of the lock knob assembly 25 between its locked and unlocked positions.

When the vehicle is locked and a person who is in possession of a proximity-actuated key (not shown) lifts the outside door handle of the vehicle, the initial movement of the outside door handle instructs the vehicle's on-board electronics to actuate the motor 50. The motor 50 causes the rotation of the lock lever 22 from the first lock lever position (FIG. 1a) through the second lock lever position (FIG. 2a) to the third lock lever position (FIG. 3). The movement of the lock lever 22 from the first lock lever position to the second lock lever position causes the lock link 20 to move from the first lock link position to the second lock link position thereby operatively connecting the second door release lever 18 to the first door release lever 16. This process of actuating the motor 50 until the second door release lever 18 is operatively connected to the first door release lever 16 preferably takes place within a selected period of time, which may be, for example, less than 50 milliseconds.

Because the lock link 20 is disengageable from the lock lever 22 (eg. during movement of the lock lever 22 between the second and third lock lever positions) the movement of the lock link 20 and the movement of the lock knob assembly 25 are independent of one another. By having the movements of the lock link 20 and the lock knob assembly 25 be independent from one another, the movement of the lock link 20 to its second position can be effected quickly so as to reduce the time to unlock the vehicle door, while the movement of the lock knob assembly 25 can remain longer so as to not require an undesirably strong (and therefore relatively expensive) motor 50. Preferably, the time required to unlock the vehicle door can be short enough so as to permit a person to open the door in one continuous motion without having to pause midway to permit the door to unlock.

To lock the vehicle door, the motor 50 is rotated so that the lock lever 22 moves from the third lock lever position through the second lock lever position to the first lock lever position. Movement of the lock lever 22 from the third lock lever position to the second lock lever position moves the lock knob assembly 25 partway from the unlocked lock knob assembly position towards the locked lock knob assembly position. When the lock lever 22 is in the second lock lever position it has reengaged with the lock link 20. It will be understood that the point at which the lock link 20 is engaged by the lock lever 22 does not necessarily have to correspond to the point at which the lock link 20 operatively connects the second door release lever 18 to the first door release lever 16. In other words, the point at which the lock link 20 is engaged by the lock lever 22 may be somewhere suitable between the second and third lock lever positions.

Movement of the lock lever 22 from the second lock lever position to the first lock lever position moves the lock link 20 from the second lock link position to the first lock link position, thereby operatively disconnecting the second door release lever 18 from the first door release lever 16.

It has been shown for the lock lever 22 to control the operative connection between the second and first door release levers 18 and 16 via the lock link 20. It is alternatively possible however, for the lock lever 22 to control the operative connection between the second and first door release levers 18 and 16 in some other way. For example, an alternative embodiment may omit the lock link and an arm on the lock lever 22 itself may be selectively positionable in between the second and first door release levers 18 and 16 based on the position of the lock lever.

While the above description constitutes a plurality of embodiments of the present invention, it will be appreciated that the present invention is susceptible to further modification and change without departing from the fair meaning of the accompanying claims.

1. A closure latch for a vehicle door, comprising:
a ratchet movable between an open position and a closed position;
a first door release lever operatively connected to the ratchet;
a second door release lever; and
a lock lever movable along a lock lever path including a first lock lever position wherein the second door release lever is operatively disconnected from the first door release lever, a second lock lever position wherein the lock lever operatively connects the second door release lever to the first door release lever, and a third lock lever position wherein the lock lever carries out an additional function.

2. A closure latch as claimed in claim 1, wherein the additional function is movement of a lock knob assembly to an unlocked lock knob assembly position.

3. A closure latch as claimed in claim 2, wherein movement of the lock lever to the first lock lever position causes movement of the lock knob assembly to a locked lock knob assembly position.

4. A closure latch as claimed in claim 1, further comprising a lock link that is movable by the lock lever between a first lock link position wherein the lock link is disengaged from the first door release lever, and a second lock link position wherein the second door release lever is operatively connected to the first door release lever through the lock link.

5. A closure latch as claimed in claim 4, wherein the lock link is biased towards the second lock link position.

6. A closure latch as claimed in claim 5, wherein at a selected point along a portion of the lock lever path between the second lock lever position and the third lock lever position, the lock lever disengages from the lock link.

7. A closure latch as claimed in claim 1, further comprising a motorized lock lever actuator that is operatively connected to the lock lever, wherein the motorized lock lever actuator is configured to move the lock lever from the first position to the second position in less than about 50 milliseconds.

8. A closure latch as claimed in claim 7, wherein the motorized lock lever actuator is controllable to move the lock lever from the first lock lever position to the third lock lever position through the second lock lever position in response to partial actuation of an outside door handle on the vehicle door.

9. A closure latch as claimed in claim 1, further comprising a pawl movable between a ratchet holding position wherein the pawl holds the ratchet in the closed position, and a ratchet release position wherein the pawl permits movement of the ratchet to the open position.

10. A closure latch as claimed in claim 8, wherein the pawl is biased towards the ratchet locking position.
